(19) United States
(12) Patent Application Publication
(10) Pub. No.: US 2016/0355769 A1
(43) Pub. Date: Dec. 8, 2016

(54) LAUNDRY ARTICLE

(71) Applicant: Henkel AG & Co. KGaA, Duesseldorf (DE)

(72) Inventors: David John Toms, Kent (GB); Avril Kate Kearney, County Cork (IE)

(73) Assignee: Henkel AG & Co. KGaA, Duesseldorf (DE)

(21) Appl. No.: 15/241,944

(22) Filed: Aug. 19, 2016

Related U.S. Application Data
(63) Continuation of application No. PCT/EP2015/051443, filed on Jan. 26, 2015.

(30) Foreign Application Priority Data
Mar. 21, 2014 (GB) 1405041.3

(51) Int. Cl. C11D 17/04; C11D 1/22; C11D 3/386; C11D 3/22; C11D 3/37

(52) U.S. Cl. CPC C11D 17/048; C11D 3/222; C11D 3/3753; C11D 3/38609; C11D 17/041; C11D 1/22; C11D 3/38627; C11D 3/38645; C11D 3/38636

(57) ABSTRACT

The present invention relates to a laundry article, a water-based composition for use in the preparation of the laundry article, and methods of preparing the water-based composition and laundry article. The laundry article comprises:
(i) a water-insoluble substrate; and
(ii) a dried water-soluble coating provided on the substrate, the dried water-soluble coating comprising:
   (a) from about 60% to about 95% by weight of at least one surfactant;
   (b) from about 0.5% to about 5% by weight of at least one enzyme;
   (c) from about 1% to about 35% by weight of at least one binder; and
   (d) from about 0% to about 15% by weight of residual water;
      the percentages by weight being percentages by weight of the total dried water-soluble coating.

### FIELD OF THE INVENTION

The present invention generally relates to a laundry article, a water-based composition for use in the preparation of the laundry article, and methods of preparing the water-based composition and laundry article.

### BACKGROUND OF THE INVENTION

It is well known that it is difficult to remove stubborn stains, including blood, carrot puree, grass, tomato sauce and mustard, from items in a laundry wash. It is also well known that consumers wish the laundry products they use to wash their laundry items, to have optimum cleaning power such that they are capable of removing such stains. It is also desirable for such laundry products to retain the whiteness of white items in a laundry wash.

Laundry products do exist, either in the form of laundry detergents, or in the form of wash boosters which are to be used as a supplement to laundry detergents, which are effective at stain removal and at keeping white items “white” for longer. However, such laundry products tend to include harsh chemicals such as bleaching agents which can adversely affect the items being washed. Such adverse effects include, but are not limited to, fading of coloured items, making the fabric items harsh to the touch, and white deposits of powder remaining on the fabric items. Furthermore, most laundry products are in the form of powders or liquids to be added by the consumer to the wash. In the case of a laundry product being a wash booster in powder format, this can have the disadvantage of being dusty meaning the user can come into contact with the harsh ingredients. In the case of a liquid wash booster, the user often has to open the container and dose the liquid into the washing machine, again making it possible that they will come into contact with the harsh ingredients.

One laundry product which attempted to provide the consumer with a more user-friendly format was sold under the Trade Mark Purex Complete 3-in-1. This product, which is no longer on the market, was a laundry sheet which comprised a water-insoluble substrate bearing a water-soluble coating containing at least a detergent and a fabric conditioner. The product was used initially as a laundry detergent in the wash (during which the water-soluble coating would dissolve and come away from the water-insoluble substrate), and, subsequently, as a fabric conditioner in the dryer. However, although the water-soluble coating of this laundry sheet was dried, it could be tacky to the touch. A further disadvantage associated with this laundry product was the use of a hot melt process to produce it, as described in the associated patent application, published as WO 2007/120867. The hot melt preparation process not only resulted in the resultant sheets being tacky or greasy, as mentioned above, but also required high temperatures as the composition used to form the water-soluble coating was only flowable when hot. Additionally, due to the hot melt process used, complex (and therefore slow and expensive) application procedures, such as a slot-coating process, were required to applying the coating. In summary, although a laundry article in sheet format has previously been prepared, it used a complex process, and the resulting product could be tacky to touch.

It is therefore an object of the invention to overcome or mitigate one or more of the above-mentioned problems.

It is also an object of the invention to provide a laundry article, preferably in the form of a wash booster, which is effective at removing stains and retaining whiteness, without the use of harsh chemicals such as bleaching agents. It is also an object of the invention to provide a laundry article which is in a more user-friendly format for the consumer than conventional powders and liquids, and which is non-tacky to touch. It is also an object of the invention to provide a method of preparation of the laundry article according to the invention, which method may advantageously be carried out at room temperature and does not involve the use of harsh solvents.

Furthermore, other desirable features and characteristics of the present invention will become apparent from the subsequent detailed description of the invention and the appended claims, taken in conjunction with this background of the invention.

### BRIEF SUMMARY OF THE INVENTION

A laundry article comprising: a water-insoluble substrate, and a dried water-soluble coating provided on the substrate, the dried water-soluble coating comprising: from about 60% to about 95% by weight of at least one surfactant, from about 0.5% to about 5% by weight of at least one enzyme, from about 1% to about 35% by weight of at least one binder, and from about 0% to about 15% by weight of residual water; the percentages by weight being percentages by weight of the total dried water-soluble coating.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

According to the invention there is provided a laundry article comprising:
(i) a water-insoluble substrate; and
(ii) a dried water-soluble coating provided on the substrate, the dried water-soluble coating comprising:
   (a) from about 60% to about 95% by weight of at least one surfactant;
   (b) from about 0.5% to about 5% by weight of at least one enzyme;
   (c) from about 1% to about 35% by weight of at least one binder; and
   (d) from about 0% to about 15% by weight of residual water;
      the percentages by weight being percentages by weight of the total dried water-soluble coating.

Preferably, the at least one surfactant comprises an anionic surfactant, a cationic surfactant, an amphoteric surfactant or a non-ionic surfactant, or a combination thereof. Further preferably, the at least one surfactant comprises an anionic surfactant, still further preferably an alkyl sulfonate, lauryl sulfate, phosphate ester or carboxylate ester surfactant. Even more preferably, the at least one surfactant comprises an alkyl sulfonate, still more preferably an alkylbenzyl sulfonate. Most preferably, the at least one surfactant is sodium cumene sulfonate (also known as (1-methylethyl)-benzenesulfonic acid, sodium salt) or sodium xylene sulfonate.

Preferably, the at least one surfactant is present in an amount of from about 65% to about 90%, more preferably from about 65% to about 85%, by weight of the dried water-soluble coating. In an embodiment, the at least one surfactant may be present in an amount of from about 65% to about 75%, preferably from about 65% to about 70%, by weight of the dried water-soluble coating. In a further embodiment, the at least one surfactant may be present in an amount of from about 70% to about 85%, preferably from about 80% to about 85%, by weight of the dried water-soluble coating.

Preferably, the at least one enzyme comprises a protease, an amylase, a mannanase, a lipase, a cellulase, a pectinase, or a combination thereof.

Preferably, the at least one enzyme is present in an amount of from about 1% to about 4.5%, by weight of the dried water-soluble coating. In an embodiment, the at least one enzyme may be present in an amount of from about 1% to about 4%, preferably from about 1% to about 3%, more preferably from about 1% to about 2%, by weight of the dried water-soluble coating. Optionally, the at least one enzyme may comprise a combination of a protease and a lipase, further optionally in a respective ratio by weight of from about 10:1 to about 20:1, preferably from about 14:1 to about 15:1. Thus, the dried water-soluble coating may comprise from about 0.5% to about 5% by weight of a combination of a protease and a lipase. In a further embodiment, the at least one enzyme may be present in an amount of from about 2% to about 4.5%, preferably from about 3% to about 4.5%, more preferably from about 4% to about 4.5%, by weight of the dried water-soluble coating. Optionally, the at least one enzyme may comprise a combination of a protease, an amylase, a mannanase, a lipase and a cellulase, further optionally in a respective ratio by weight of about 10:4:2:2:1. Thus, the dried water-soluble coating may comprise from about 0.5% to about 5% by weight of a combination of a protease, an amylase, a mannanase, a lipase and a cellulase.

Preferably, the at least one binder comprises a film forming water soluble polymer. Optionally, the at least one binder comprises polyvinyl alcohol, polyvinyl acetate, polyvinyl pyrrolidone, poly(ethylene oxide), carboxy methyl cellulose or hydroxyl ethyl cellulose, or a combination thereof. The binder conveniently acts to bind the components in the water-soluble coating, such as the at least one surfactant and the at least one enzyme, to the water-insoluble substrate.

Preferably, the at least one binder is present in an amount of from about 1% to about 30% by weight of the dried water-soluble coating. In an embodiment, the at least one binder may be present in an amount of from about 1% to about 20%, preferably from about 1% to about 10%, more preferably from about 5% to about 10%, by weight of the dried water-soluble coating. Optionally, the at least one binder may comprise a combination of polyvinyl alcohol and hydroxyethyl cellulose, further optionally in a respective ratio by weight of from about 1:1 to about 2:1, preferably about 1.6:1. Thus, the dried water-soluble coating may comprise from about 1% to about 35% by weight of a combination of polyvinyl alcohol and hydroxyethyl cellulose. In a further embodiment, the at least one binder may be present in an amount of from about 1% to about 5%, preferably from about 1% to about 3%, by weight of the dried water-soluble coating. Optionally, the at least one binder is hydroxyethyl cellulose.

As used herein, the term “residual water” is intended to mean water that remains in the dried water-soluble coating after the water-based composition has been dried to form the dried water-soluble coating. The residual water may come from the added water component or from water that was present in water-based preparations of the ingredients.

Preferably, the residual water is present in an amount of from about 0% to about 10% by weight of the dried water-soluble coating. In an embodiment, the residual water may be present in an amount of from about 0% to about 5%, preferably from about 0% to about 2%, more preferably from about 0% to about 1%, still more preferably from about 0% to about 0.5%, by weight of the dried water-soluble coating. Even more preferably, the dried water-soluble coating comprises substantially no residual water. In a further embodiment, the residual water may be present in an amount of from about 5% to about 10%, preferably from about 7% to about 10%, by weight of the dried water-soluble coating.

The dried water-soluble coating may also comprise a de-aerator in an amount of from about 0.01% to about 5%, preferably from about 0.05% to about 2.5% by weight of the dried water-soluble coating.

Preferably the de-aerator comprises an allyloxy alcohol, optionally 2-allyoxyl ethanol. In an embodiment, the de-aerator may be present in an amount of from about 1.5% to about 3%, preferably from about 2% to about 2.5%, more preferably about 2.2%, by weight of the dried water-soluble coating. In a further embodiment, the de-aerator may be present in an amount of from about 0.02% to about 0.1%, preferably from about 0.04% to about 0.08%, more preferably about 0.06%, by weight of the dried water-soluble coating. The de-aerator is conveniently used to enable the water-based composition to dissolve at least all of the surfactant and enzyme active ingredients therein.

Optionally, the dried water-soluble coating may comprise other components including, but not limited to, one or more preservatives, pigments, fillers, plasticisers, anti-bacterial agents, dyes, fabric softeners, dye scavenging compounds, anti-soil re-deposition agents, optical brightening agents, UV absorbers, starches, perfumes, and combinations thereof.

The preservative, if present, may be present in an amount of from about 0.05% to about 10%, preferably from about 1% to about 8%, by weight of the dried water-soluble coating.

The pigment, if present, may be present in an amount of from about 0.01% to about 2%, preferably from about 0.05% to about 1%, by weight of the dried water-soluble coating. The pigment may conveniently be used to impart a colour to the dried water-soluble coating.

The plasticiser, if present, may be present in an amount of from about 0.05% to about 3%, preferably from about 1% to about 2% by weight of the dried water-soluble coating. The plasticiser may conveniently be used to ensure the dried coating on the flexible water insoluble substrate does not crack during processing, storage or use.

The filler, if present, may be present in an amount of from about 10% to about 20%, preferably from about 12% to about 16% by weight of the dried water-soluble coating. The filler may conveniently be used to produce a more prominent coating on the flexible sheet.

The dried water-soluble coating is conveniently non-tacky to the touch. Non-tacky is intended to mean that the dried-water soluble coating has no adhesion to another surface when they are in contact. Thus, the non-tacky coating conveniently does not stick to a user's hands when handling the laundry article.

The dried water-soluble coating may be provided as a continuous or non-continuous layer on the water-insoluble substrate, preferably a continuous layer.

The water-insoluble substrate is preferably a flexible, absorbent substrate, and may be formed from any suitable material. The substrate may be woven or non-woven, preferably non-woven. The substrate may comprise a naturally occurring material or a synthetic material or a mixture thereof. Examples of suitable materials include cellulosic materials such as viscose, cotton, wood pulp, paper, and mixtures thereof; and non-cellulosic materials such as polymers, optionally selected from polyester, polyethylene and polypropylene, or a combination thereof. The substrate may comprise a mixture of one or more cellulosic and one or more non-cellulosic materials, if desired.

In an embodiment, the water-insoluble substrate may comprise a blend of viscose and polyester, preferably a blend of viscose and polyester, polyethylene and polypropylene. In a preferred embodiment, the water-insoluble substrate may comprise a needle punch non-woven material, optionally having a weight of from about 70 gsm to about 300 gsm, preferably about 80 gsm.

The water-insoluble substrate may comprise viscose and polyester and a combination of polyethylene/polypropylene in a ratio by weight in the range of from about 50:35:15 to about 70:15:15, preferably about 55:30:15. However, it will be appreciated that the combination of polyethylene/polypropylene is not limited to being present in an amount of 15% by weight. In a preferred embodiment, the water-insoluble substrate comprises about 55% by weight viscose, about 30% by weight polyester and about 15% by weight bico, wherein bico is combination of polyethylene and polypropylene available from FiberVisions, Denmark, for example. The substrate may be prepared using a conventional needle punch method.

In another embodiment, the substrate may comprise a blend of viscose and cotton in a ratio by weight in the range of from about 70:30 to about 30:70, optionally from about 60:40 to about 40:60, further optionally about 50:50. In this embodiment, the substrate may comprise a binder such as polyvinylacetate. A suitable substrate may be a substrate comprising viscose and cotton in a 50:50 ratio by weight, and optionally including a binder, as disclosed for example in International PCT Patent Publication No. WO 97/48789 A. However, it will be appreciated by a skilled person that the substrate is not limited to being made from the above-listed materials, and be made from any other suitable material(s), cellulosic or otherwise.

In an embodiment, the water-insoluble substrate bears a dye scavenging compound selected from the following compounds:
(i) N-trisubstituted ammonium-2-hydroxy-3-halopropyl compound having the general formula (I)

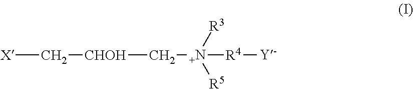

wherein R³, R⁴, R⁵ are each independently methyl, ethyl, butyl or benzyl or an hydroxyl substituted derivative thereof, X′ is a halogen atom, and Y′⁻ is chloride, bromide, sulfate or sulfonate; and
(ii) a salt of epoxy propyl ammonium having the general formula (II),

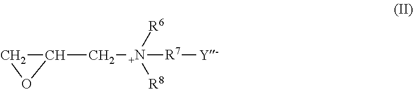

wherein R⁶, R⁷, R⁸ and Y″⁻ have the same meaning as R³, R⁴, R⁵ and Y′⁻, respectively, as defined above; or a combination thereof.

As used herein, a “dye scavenging compound” is a compound which generally inhibits any dyestuff or colorant present in wash water from being undesirably absorbed, adsorbed, reacted with, or otherwise physically deposited on or associated with items in the wash water. The dye scavenging compound which is applied to, adsorbed by, or impregnated into the water-insoluble substrate is generally a compound which has a high affinity for dyes or colorants and is generally capable of complexing therewith.

A particularly preferred dye scavenging compound used in the present invention is a compound of the formula (I) which is 3-chloro-2-hydroxypropyltrimethylammonium chloride. Another particularly preferred dye scavenging compound is a compound of the formula (II) which is glycidyltrimethylammonium chloride, also known as (2,3-epoxypropyl)trimethylammonium chloride.

The dye scavenging compound (I) and/or (II), when present, is preferably present in an amount of from approximately 0.5 g to 20.0 g, more preferably from approximately 3.0 g to 9.0 g, especially approximately 6.0 g per square metre of water-insoluble substrate.

It will be appreciated that the dye scavenging compound may be applied to the water-insoluble substrate using the method disclosed for example in International PCT Patent Publication No. WO 97/48789 A.

It will also be appreciated that the water-insoluble substrate is not limited to the water-insoluble substrate described herein. For example, the water-insoluble substrate is not limited to having a dye scavenging compound applied thereto, and may be used without being pretreated with the dye scavenging compound. Furthermore, the non-woven substrate may vary in composition from the materials forming the water-insoluble substrate described above.

The laundry article according to the invention is preferably in the form of a flexible sheet. The laundry article according to the invention is preferably a wash booster or stain remover to be used as a supplement to laundry detergent in a wash.

The invention also provides a water-based composition for applying to the water-insoluble substrate, the water-based composition comprising:
(a) from about 20% to about 50% by weight of at least one surfactant;
(b) from about 5% to about 35% by weight of at least one enzyme;
(c) from about 0.5% to about 15% by weight of at least one binder; and
(d) from about 10% to about 50% by weight of water;
   the percentages by weight being percentages by weight of the total water-based composition.

Preferably, the at least one surfactant is as defined above for the dried water-soluble coating. Preferably, the at least one surfactant is present in an amount of from about 30% to about 45% by weight of the water-based composition. In an embodiment, the at least one surfactant may be present in an amount of from about 30% to about 35% by weight of the water-based composition. In a further embodiment, the at least one surfactant may be present in an amount of from about 40% to about 45% by weight of the water-based composition.

Preferably, the at least one enzyme is as defined above for the water-soluble coating. Preferably, the at least one enzyme is present in an amount of from about 5% to about 30% by weight of the water-based composition when in its commercially available liquid form. In an embodiment, the at least one enzyme may be present in an amount of from about 5% to about 10%, preferably from about 6% to about 8%, by weight of the water-based composition. Optionally, the at least one enzyme may comprise a combination of a protease and a lipase. Thus, the water-based composition may comprise from about 5% to about 35% by weight of a combination of a protease and a lipase. In a further embodiment, the at least one enzyme may be present in an amount of from about 25% to about 35%, preferably from about 25% to about 30%, by weight of the water-based composition. Optionally, the at least one enzyme may comprise a combination of a protease, an amylase, a mannanase, a lipase and a cellulose. Thus, the water-based composition may comprise from about 5% to about 35% by weight of a combination of a protease, an amylase, a mannanase, a lipase and a cellulase.

Preferably, the at least one binder is as defined above for the water-soluble coating. Preferably, the at least one binder is present in an amount of from about 1% to about 15% by weight of the water-based composition. In an embodiment, the at least one binder may be present in an amount of from about 10% to about 15%, preferably from about 10% to about 12%, by weight of the water-based composition. Optionally, the at least one binder may comprise a combination of polyvinyl alcohol and hydroxyethyl cellulose. Thus, the water-based composition may comprise from about 0.5% to about 15% by weight of a combination of polyvinyl alcohol and hydroxyethyl cellulose. In a further embodiment, the at least one binder may be present in an amount of from about 1% to about 5%, preferably from about 1% to about 2%, by weight of the water-based composition. Optionally, the at least one binder is hydroxyethyl cellulose.

Preferably, the water present in the composition conveniently acts as a solvent in which the at least one surfactant, at least one enzyme, and at least one binder, dissolve at ambient temperature of from about 10° C. to about 30° C., preferably from about 15° C. to about 25° C., more preferably at room temperature of about 19° C. or about 20° C.

Preferably, water is present in an amount of from about 15% to about 45%, preferably from about 15% to about 40% by weight of the water-based composition. In an embodiment, the water may be present in an amount of from about 35% to about 45%, preferably from about 40% to about 45%, by weight of the water-based composition. In a further embodiment, the water may be present in an amount of from about 10% to about 20%, preferably from about 15% to about 20%, by weight of the water-based composition.

The water-based composition may also comprise a de-aerator in an amount of from about 0.01% to about 5%, preferably from about 0.05% to about 2.5%, more preferably about 1% by weight of the water-based composition. Preferably the de-aerator is as defined above for the water-soluble coating.

Optionally, the water-based composition may comprise other components including, but not limited to, one or more preservatives, pigments, fillers, plasticisers, anti-bacterial agents, dyes, fabric softeners, dye scavenging compounds, anti-soil re-deposition agents, optical brightening agents, UV absorbers, starches, perfumes, and combinations thereof.

The preservative, if present, may be present in an amount of from about 1% to about 10%, preferably from about 3% to about 7% by weight of the water-based composition.

The pigment, if present, may be present in an amount of from about 0.01% to about 2%, preferably from about 0.05% to about 1% by weight of the water-based composition.

The plasticiser, if present, may be present in an amount of from about 0.05% to about 3%, preferably from about 0.5% to about 1% by weight of the water-based composition.

The filler, if present, may be present in an amount of from about 2% to about 10%, preferably from about 5% to about 8% by weight of the dried water-soluble coating.

For the ingredients of the water-based composition, it will be appreciated by the skilled person that where the ingredient is provided commercially as a solid ingredient in solution, the weight % of the ingredients refer to the weight % of the commercially available liquid form containing the ingredient in solution. For example, in the case of a commercially available enzyme preparation containing 10% solid enzyme in liquid, the weight % of the ingredient in the water-based composition refers to the weight % of the liquid preparation. This is in contrast to the weight % of ingredients referred to in dried water-soluble coating, which weight % refer to the amount of the solid ingredients per se.

The water-based composition preferably has a viscosity of from about 10000 cp to about 15000 cp, more preferably from about 11000 cp to about 14000 cp, even more preferably from about 12000 cp to about 13000 cp, most preferably about 12200 cp, at 20° C., as measured by Brookfield viscometer Spindle No. 6 cup No. 3. The water-based composition is conveniently a homogeneous liquid which is capable of being dried on the water-insoluble substrate, as described below, to form the dried water-soluble coating of the laundry article of the invention.

The invention further provides a method of preparing a water-based composition according to the present invention, comprising the steps of:
(A) combining the following ingredients:
   (a) from about 20% to about 50% by weight of at least one surfactant;
   (b) from about 5% to about 35% by weight of at least one enzyme;
   (c) from about 0.5% to about 15% by weight of at least one binder; and
   (d) from about 10% to about 50% by weight of water;
the percentages by weight being percentages by weight of the total water-based composition; and
(B) stirring the combined ingredients until the at least one surfactant, at least one enzyme, and at least one binder, have dissolved in the water;

wherein steps (A) and (B) are carried out at a temperature of from about 10° C. to about 30° C.

Preferably, the steps (A) and (B) of the method are carried out at a temperature of from about 15° C. to about 25° C., more preferably from about 18° C. to about 22° C., most preferably about 19° C. or about 20° C.

In step (A), the ingredients of the water-based composition are preferably combined in the following order of addition:
(i) add the at least one surfactant to the water;
(ii) add the at least one binder to the resulting mixture; and
(iii) add the at least one enzyme to the resulting mixture.

Preferably, the method also comprises the step of adding a de-aerator to the water-based composition in an amount of from about 0.01% to about 5% by weight of the water-based composition.

Preferably, the de-aerator is added to the water-based composition before the at least one surfactant is added to the water. Thus, in step (A), the ingredients of the water-based composition are preferably combined in the following order of addition:
(i(a)) add the de-aerator to the water;
(i(b)) add the at least one surfactant to the resulting mixture;
(ii) add the at least one binder to the resulting mixture; and
(iii) add the at least one enzyme to the resulting mixture.

Preferably, the at least one surfactant, the at least one enzyme, the at least one binder, and the at least one de-aerator, are as defined herein.

It is proposed that the addition of the de-aerator to the water as the first step of the method enables the remaining ingredients to be dissolved in the water without difficulty at a temperature of from about 10° C. to about 30° C., preferably from about 15° C. to about 25° C., more preferably from about 18° C. to about 22° C., most preferably at room temperature of about 19° C. or at about 20° C. Without the de-aerator, a large amount of air would be incorporated into the liquid as the large concentration of powder ingredients are incorporated. This air would be impossible to remove from the viscous liquid and would ultimately cause the binder to dry, making the liquid unusable to apply to the substrate.

The invention still further provides a method of preparing a laundry article according to the present invention, comprising the steps of:
(I) applying a water-based composition according to the invention to a water-insoluble substrate to form a coated substrate; and
(III) drying the coated substrate;
   wherein step (I) is carried out at a temperature of from about 10° C. to about 30° C.

Preferably, step (I) is carried out at a temperature of from about 15° C. to about 25° C., more preferably from about 18° C. to about 22° C., most preferably about 19° C. or at about 20° C.

Preferably, step (I) comprises applying the water-based composition to the water-insoluble substrate using rotary screen printing. Further preferably, step (I) comprises applying the water-based composition to the water-insoluble substrate using two or more rotary screen printers in series, without drying the coated substrate between applications of the water-based composition.

Further preferably, step (II) comprises drying the coated substrate at a temperature of from about 80° C. to about 160° C., preferably about 110° C., for from about 1 minute to 15 minutes with a preferred time of 2-3 minutes.

Preferably, the method further comprises cutting the prepared laundry article into sheets of size range 8-30 cm×8-30 cm, preferably 16 cm×12 cm, before placing in the final packaging.

Preferably, the water-based composition in step (I) is prepared according to the method defined herein.

Alternatively, step (I) may comprise applying the water-based composition to the water-insoluble substrate using a knife-over-roller method or flat bed screen printer method.

Preferably, the water-based composition and the water-insoluble substrate in step (I) are as defined herein.

Preferably, step (I) comprises applying the water-based composition to one side of the water-insoluble substrate. However, it will be appreciated that the water-based composition may alternatively be applied to both sides of the water-based composition. In this case, the water-insoluble substrate may be coated on both sides either in a single pass through the one or more rotary screens, or using two passes through the one or more rotary screens. In this case, the water-based composition provided on each side of the water-insoluble substrate may be the same or different. Furthermore, once the prepared laundry article has been dried and cut to size (for example 16 cm×12 cm), it may be folded in half and the three unsealed sides subjected to heat and/or pressure to fuse the two halves together, to form a sealed package with the water-soluble coating on the inside, which would open in the wash.

The invention even further provides a laundry article obtainable by the method described above.

Advantages of the invention include, but are not limited to the following:
The dried water-soluble coating of the laundry article of the invention is non-tacky, meaning that no protective sheet is required between the laundry articles in the final packaging. The non-tackiness also means that none of the dried water-soluble coating transfers onto consumers' hands when it is being handled normally. Accordingly, there is no danger of consumers' hands being left with an undesirable residue after contact, unlike some conventional products. Even if some residual water remains in the dried water-soluble coating after drying, the dried water-soluble coating is still surprisingly non-tacky to the touch.
The dried water-soluble coating provides a tactile surface so that consumers can feel that it is present. It is also, preferably, provided with a pigment so that the dried water-soluble coating is clearly visible to consumers. For example, using the pigment Magnaprint Eco Blue HB 10%, the resultant dried water-soluble coating will have a blue tint that largely washes out in use.
The laundry article is particularly easy to use. For example, as a wash booster, the consumer simply removes a single sheet (laundry article) from the packaging, and places it in the washing machine along with the items to be washed. When the laundry article is being used as a wash booster, laundry detergent is also added to the wash as usual. During the wash, the dried water-soluble coating conveniently dissolves in the wash water, releasing the components of the dried water-soluble coating into the wash. After the wash, the consumer can see that a change has taken place (i.e. that the water-soluble substrate has dissolved). Advantageously, if a dye scavenging compound is present on the water-insoluble substrate, the laundry article of the present invention also has the added benefit of being able to scavenge extraneous or free-flowing dyes or stains present in the wash water. Thus, the water-insoluble substrate may end up being stained by dyes or stains present in the wash water, as the dye scavenging compound is not released from the water-insoluble substrate. In this case, the consumer can see that an additional change has taken place (i.e. as a result of the water-insoluble substrate becoming stained). Thus, the laundry article according to the invention is capable of performing multiple functions.
The laundry article does not use any harsh chemicals such as bleaching agents. Furthermore, it achieves improved cleaning compared to other bleach-free water-soluble products such as Dizolve™. It not only provides highly effective stain removal, but also maintains the whiteness of white fabrics being washed.
The water-based composition according to the invention (which, when dried, forms the dried water-soluble coating), is conveniently capable of dissolving large amounts of ingredients at an ambient temperature of from about 10° C. to about 30° C., preferably at room temperature of about 19° C. or about 20° C. As will be appreciated from the Examples, the whole process from making the water-based composition to applying the water-based composition to the water-insoluble substrate, may be carried out at room temperature of about 19° C. or about 20° C., or at ambient temperature ranging from about 10° C. to about 30° C., in contrast to prior art methods. The fact that the water-based composition is flowable at room temperature means that the method of application of the water-based composition to the water-insoluble substrate may be carried out without using complex and laborious processes and equipment. The fact that a hot process is not required means that enzymes can conveniently be included in the water-based composition, which is not possible with some prior art methods as the enzymes would be denatured. Additionally, the process is almost totally water based rather than using any hazardous solvents such as methanol in order to stabilize the enzymes. Furthermore, the water-based composition includes enough water for the ingredients to be dissolved, but not so much water that the enzymes might be adversely affected (generally >50% water content).

The following Examples serves to illustrate the invention but it will be appreciated that the invention is not limited to these Examples.

### EXAMPLE 1

A water-based composition according to the invention was prepared in accordance with the ingredients shown in Table 1.

TABLE 1

| | | | (II) | |
|---|---|---|---|---|
| | | (I) | wt % of | |
| | | wt % of | ingredients | |
| | | ingredients | based on | |
| | | based on | total dried | |
| | | total water- | water- | |
| | | based | soluble | Order of |
| Trade name | Description | composition | coating | addition |
| Eltisol SC93, | Sodium cumene | 30.50 | 66.61 | 6 |
| available from | sulphonate (surfactant), | | | |
| Huntsman | solid | | | |
| Liquanase Ultra | Protease (enzyme), | 6.00 | 1.31 | 12 |
| 2.5 L available | solution in water | | | |
| from | | | | |
| Novozymes | | | | |
| Lipex 100 L | Lipase (enzyme), | 0.80 | 0.09 | 11 |
| available from | solution in water | | | |
| Novozymes | | | | |
| Acticide MBS | 2.5% | 0.90 | 1.97 | 2 |
| 25/50 available | methylisothiazolinone | | | |
| from Thor | (MIT)/2.5% | | | |
| Specialities Ltd | benzisothiazolinone | | | |
| | (BIT) (preservative), | | | |
| | solution in water | | | |
| Acticide M20 | 20% | 2.60 | 5.68 | 3 |
| available from | methylisothiazolinone | | | |
| Thor | (MIT) (preservative), | | | |
| Specialities Ltd | solution in water | | | |
| Santisizer | 89.4% dipropylene | 0.50 | 1.09 | 4 |
| ER9100 | glycol dibenzoate | | | |
| available from | (plasticiser), liquid | | | |
| Magna Colours | | | | |
| Magnaprint Eco | Cl Pigment Blue 15:1 | 0.30 | 0.66 | 10 |
| Blue HB 10% | (blue pigment), | | | |
| available from | dispersion in water | | | |
| Magna Colours | | | | |
| Hansa | 3.5% 2(allyoxyl) ethanol | 1.00 | 2.18 | 5 |
| ADD4035 | (de-aerator), solution in | | | |
| available from | water | | | |
| CHT Chemicals | | | | |
| Polytab TA463 | PVOH solution (binder), | 10.00 | 3.82 | 9 |
| available from | 17.5% solids in water | | | |
| Goldcrest | | | | |
| Natrasol | Hydroxy ethyl cellulose | 1.10 | 2.40 | 8 |
| MBR250, | (binder), solid | | | |
| available from | | | | |
| Ashland | | | | |
| Available from | China Clay (filler), solid | 6.50 | 14.20 | 7 |
| Imerys | | | | |
| Water | Solvent, liquid | 39.80 | 0 | 1 |
| Total | | 100.00 | 100.01 | |

A 1 tonne batch of the water-based composition was prepared by mixing the ingredients according to the “Order of addition” and based on the amounts shown in the column numbered (I) of Table 1. The preparation was carried out at room temperature of 19° C. with constant stirring. Further details of the process are provided below.

The water was added to a 1.2 tonne capacity vessel. The paddle stirrer was started and the preservatives were added. While continuing to stir, the Santisizer ER9100 and Hansa ADD4035 were added. While stirring, the Eltisol SC93 and china clay were added slowly. The mixture was stirred continuously for 10 minutes until all of the above ingredients had dissolved in the water. The Natrosol MBR250 was then added slowly while stirring, and stirring was continued for 10 minutes until fully dissolved in the water. The Polytab TA463 solution was then added while stirring. Finally, the Magnaprint Eco Blue HB 10%, Lipex 100 L and Liquanase Ultra 2.5L were added, again while stirring. The mixture was then stirred for 10 minutes until a homogenous mixture was achieved. The whole process was carried out at room temperature of 19° C. The resultant water-based composition was a homogeneous liquid having a viscosity of 12200 cp at 20° C.

### EXAMPLE 2

A laundry article according to the invention was prepared as follows.

(A) Preparation of Water-Insoluble Substrate

A water-insoluble substrate comprising a needle punch non-woven 80 gsm substrate (55% by weight viscose, 30% by weight polyester and 15% by weight bico (50:50 combination of polyethylene and polypropylene, available from FiberVisions, Denmark)), was prepared in accordance with conventional needle punch methods. The prepared water-insoluble substrate had a thickness of 1 mm.

The prepared water-insoluble substrate had a dye scavenging compound applied thereto in accordance with the method described in International PCT Patent Publication No. WO 97/48789 A. In brief, the substrate was passed through an alkaline solution (30% NaOH solution) of Reagens CFZ (dye scavenging compound 3-chloro-2-hydroxypropyltrimethylammonium chloride) at 45° C. The substrate was subsequently subjected to a pressure of approximately 1.03 MPa (150 psi) by being passed through hydraulically actuated rollers at a rate of approximately 175 mm s⁻¹. The substrate was then heated by passing it through a series of rollers having a temperature of 100° C., the substrate exiting the rollers having a temperature of 35° C. The substrate was stored for approximately six hours rotating continuously. Subsequently, the substrate was passed through an acid solution comprising 5 molar HCl solution. The substrate was subjected to a pressure of 1.37 MPa (200 psi) by being passed through rollers at a rate of 83 mm s⁻¹. An infra red dryer operating at 286° C. was used to dry the substrate. The substrate was dried completely prior to use. The resultant substrate was a water-insoluble non-woven substrate bearing the dye scavenging compound in an amount of 6.0g per square metre of water-insoluble substrate.

(B) Preparation of Laundry Article

The water-based composition prepared in Example 1 was applied to the water-insoluble substrate of Example 2(A) (width 185 cm) as follows, to provide 100% coverage on one side of the water-insoluble substrate. The application process was carried out at room temperature of 19° C.

The water-based composition prepared in Example 1 was applied in an amount of 218g water-based composition per square metre of water-insoluble substrate. The water-based composition was applied from four consecutive rotary screen print stations, all provided in series on the same production line (a Reggiani Unica rotary screen printing machine), and each print station having a screen of mesh 40 holes per inch. The coated substrate was not dried between screens. Application from the four screens was required to build up the required 218 gsm wet formula (water-based composition). The running speed of the screen printer was 35 m per minute. After application of the water-based composition by the four screens as described above, the coated substrate was dried at a temperature of 110° C. for 2½ minutes, such that the water-based composition dried to form a dried water-soluble coating on the water-insoluble substrate, so as to form the laundry article of the invention.

The laundry article comprising the dried water-soluble coating provided on the water-insoluble substrate was wound up at the end of the process, for subsequent converting into the final article size. The laundry article was subsequently converted (by slitting and packing) into sheets of dimensions 16 cm×12 cm, 14 per pack in a carton. The laundry article was non-tacky to the touch, and, therefore, required no protective sheet to be provided between the laundry sheets in the final packaging. One sheet of 16 cm×12 cm is used per wash.

The wt % of the ingredients based on the total dried water-soluble coating are shown in the column numbered (II) of Table 1.

It will be appreciated by the skilled person from reading the present specification, that the weight % of ingredients indicated in column (II) as being % by weight of total dried water-soluble coating, is based on the weight % of the actual (solid) ingredients. In contrast, the weight % of ingredients indicated in column (I) as being % by weight of the total water-based composition, is based on the weight % of the indicated preparations. Thus, it will be appreciated by the skilled person that in the case of a preparation including 10% solid ingredient in solution, the weight % indicated in column (II) refers to the weight % of actual solid ingredient forming part of the dried water-soluble coating, whereas the weight % indicated in column (I) refers to the weight % of the liquid preparation containing 10% solid ingredient in solution, i.e. the weight % of its commercially available liquid form. Thus, in the case of the components of the water-based composition, the weight % applies to the weight % of the liquid preparation of the (solid) components in those cases that a liquid preparation is used. It will be further appreciated by a skilled person that the same applies to the weight % ranges used herein throughout the specification when describing the invention, e.g. for the water-soluble coating (weight % of actual solid ingredient), and water-based composition (weight % of preparation). It will still further be appreciated by a skilled person that the amounts of solid ingredients forming part of the dried water-soluble coating may be calculated based on the composition of the various components indicated.

### EXAMPLE 3

A water-based composition according to the invention was prepared in accordance with the ingredients shown in Table 2.

TABLE 2

| | | | (II) | |
|---|---|---|---|---|
| | | (I) | wt % of | |
| | | wt % of | ingredients | |
| | | ingredients | based on | |
| | | based on | total dried | |
| | | total water- | water- | |
| | | based | soluble | Order of |
| Trade name | Description | composition | coating | addition |
| Eltisol SC93 available | Sodium cumene | 45.0 | 81.82 | 6 |
| from Huntsman | sulphonate | | | |
| | (surfactant), solid | | | |
| Liquanase Ultra 2.5 L | Protease (enzyme), | 11.90 | 2.16 | 13 |
| available from | solution in water | | | |
| Novozymes | | | | |
| Stainzyme Plus 12 L | Amylase (enzyme), | 4.76 | 0.87 | 9 |
| available from | solution in water | | | |
| Novozymes | | | | |
| Mannaway 4.0 L | Mannanase (enzyme), | 4.76 | 0.43 | 10 |
| available from | solution in water | | | |
| Novozymes | | | | |
| Lipex 100 L available | Lipase (enzyme), | 4.76 | 0.38 | 11 |
| from Novozymes | solution in water | | | |
| Carezyme 4500 L | Cellulase (enzyme), | 2.38 | 0.22 | 12 |
| available from | solution in water | | | |
| Novozymes | | | | |
| Acticide MBS 25/50 | 2.5% | 1.80 | 0.25 | 2 |
| available from Thor | methylisothiazolinone | | | |
| Specialities | (MIT)/5% | | | |
| | benzisothiazolinone | | | |
| | (BIT) (preservative), | | | |
| | solution in water | | | |
| Optiphen MIT | 10% | 5.00 | 0.91 | 3 |
| available from | methylisothiazolinone | | | |
| Ashland | (MIT) (preservative), | | | |
| | solution in water | | | |
| Santisizer ER9100 | 89.4% dipropylene | 1.00 | 1.62 | 4 |
| available from Magna | glycol dibenzoate | | | |
| Colours | (plasticiser), liquid | | | |
| Magnaprint Eco Blue | CI Pigment Blue 15:1 | 0.50 | 0.05 | 8 |
| HB 10% available | (blue pigment), | | | |
| from Magna Colours | dispersion in water | | | |
| Hansa ADD4035 | 3.5% 2(allyoxyl) | 1.00 | 0.06 | 5 |
| available from CHT | ethanol (de-aerator), | | | |
| Chemicals | solution in water | | | |
| Natrasol MBR250 | Hydroxy ethyl | 1.20 | 2.18 | 7 |
| available from | cellulose (binder), | | | |
| Ashland | solid | | | |
| water | Solvent, liquid | 15.94 | 9.06 | 1 |
| Total | | 100.00 | 100.00 | |

The water-based composition was prepared by mixing the ingredients according to the “Order of addition” and based on the amounts shown in the column numbered (I) of Table 2. The preparation was carried out at room temperature of 19° C. with constant stirring. The preparation was carried out as described in Example 1, except for substitution with the ingredients and amounts indicated in the column numbered (I) of Table 2 (and omitting the filler as it is not present in this example).

### EXAMPLE 4

A laundry article according to the invention was prepared as follows.

(A) Preparation of Water-Insoluble Substrate (See Example 2(A) Above)

(B) Preparation of Laundry Article

The water-based composition prepared in Example 3 was applied to the water-insoluble substrate as described in Example 2(B), and was dried to form a dried water-soluble coating on the substrate.

### EXAMPLE 5

The following tests were performed to show the improved washing efficiency, i.e. cleaning and stain removal, and improved whiteness, achieved using the laundry article according to the invention.

The laundry article prepared in Example 2(B) using the water-based composition prepared in Example 1 is referred to below as Laundry Article 2(B).

The laundry article prepared in Example 4(B) using the water-based composition prepared in Example 3 is referred to below as Laundry Article 4(B).

Materials and Equipment Used:
Washing Machine: Miele Novotronic W544, 30° C. cycle.
Number of repeats for each test: 6 without cumulative effect for stain removal (see (A) below), 6 with cumulative effect for whiteness (see (B) below).
Water hardness: 25±2 French degrees.
Load: 3 kg cotton cloths (i.e. 6 cloths per wash, 0.5 kg each; purpose of these cloths is to simulate a full wash load of fabric.).
Detergent: 70 g ECE2 (ECE2 is a standard reference detergent conventionally used in such tests and which is available from WFK, Germany).
Ballast load: 4 WFK-SBL 2004 pieces per load. SBL 2004 is a standard soiled sheet used in the AISE protocol (used herein for these tests) to simulate normally soiled laundry (the sheets have sebum/oil load and a “bleach consuming agent”).
Stains: standard stained sheets as per AISE, (International Association for Soaps, Detergents and Maintenance Products, Brussels) standard protocol. For example, the standard stained sheet for blood is called Blood EQUEST, the stained sheets for carrot puree, grass, tomato sauce and mustard are also standard stained sheets available from suppliers such as EQUEST or WFK.
White fabric: cotton KREFELD 10A (this is additional to the 3 kg cotton cloths above).

For each test, 70 g of ECE2 reference detergent, a laundry article being tested, 3 kg cloths, a single white cotton KREFELD A fabric as referred to above, ballast load and a standard stained sheet being tested, are all added to the machine and the 30° C. cycle run.

(A) Stain Removal:

Measurement Method:

Stains on the standard stained sheets were measured before and after washing using a spectrophotometer and the amount of staining removed calculated:
Removal %=C−B/A−Bx100
A=reflectance of white cotton KREFELD A fabric before wash
B=Reflectance of the stained sheet before washing
C=reflectance of the stained sheet (after washing)

Measurements carried out without optical brightener effect.

Results:

The results of the stain removal tests are shown in Table 3 below. A 2 point (i.e. 2%) difference is seen as significant.

TABLE 3

| | | Carrot | | Tomato | |
|---|---|---|---|---|---|
| | Blood | Puree | Grass | Sauce | Mustard |
| Detergent alone | 69.8% | 61.7% | 22.6% | 64.9% | 43.3% |
| Detergent + Laundry | 77.2% | 65.7% | 35.2% | 77.1% | 49.4% |
| Article 2(B) | | | | | |
| Detergent + Laundry | 77.1% | 69.8% | 38.3% | 77.8% | 46.2% |
| Article 4(B) | | | | | |
| Detergent + Dizolve ™¹ | 70.3% | 61.6% | 24.8% | 64.3% | 35.9% |

¹a water-soluble detergent sheet, available from Prelam Enterprises Ltd. The packaging of Dizolve ™ indicates that this product comprises 15-30% anionic surfactants, 5-15% soap, <5% non-ionic surfactants, <5% amphoteric surfactants, and enzymes.

Referring to Table 3, the laundry articles according to the invention produced significantly better results on removal of all of the above stains, compared with using ECE2 detergent alone, and also compared with ECE2 detergent plus a commercially available laundry detergent sheet, Dizolve™.

(B) Whiteness:

The whiteness of the single KREFELD 10A white cotton fabric included in the wash was tested—the same piece of cotton fabric was washed 6 times in the load previously described (including the SBL2004 sheets and stained fabrics) and the whiteness at the end of the 6 cycles measured. This test measures how effective a product is at preventing the soil in the wash from being re-deposited back onto white fabric.

Measurement method: according to Ganz formula with Ultra Violet:
Whiteness degree (W) and tint value (TV) are calculated according to:

W=D×Y+P×x+Q×y+C
with:
D, P, Q, C: spectrophotometer parameters
Y, x, y: colorimetric values

TV=m×x+n×y+k
with:
m, n, k: spectrophotometer parameters
x, y: colorimetric values

Tintings and shadings are expressed with positive (greening/bluing) and negative numbers (reddishing).

Tint values (TV) are evaluated as follows :
Between −0.5 to 0.5: TD=N® neutral shade
Between −0.5 to −1.5: TD=R1® slight to visible reddish shade
Between −1.5 to −2.5: TD=R2® visible reddish shade
Between −2.5 to −3.5: TD=R3® distinct reddish shade
Between 0.5 to 1.5: TD=G1® slight greenish shade
Between 1.5 to 2.5: TD=G2® visible greenish shade
Between 2.5 to 3.5: TD=G3® distinct greenish shade

A 10 points difference is considered as significant.

Results:

The results of the whiteness tests are shown below. The higher the number, the whiter the fabric remains. A 10 point difference is seen as significant.
1. Detergent+Laundry Article 2(B) @30° C.=66
2. Detergent+Laundry Article 4(B) @30° C.=67
3. Detergent plus Dizolve @30° C.=59
4. Detergent alone @30° C.=54

Referring to the above results, the laundry article according to the invention produced significantly better results on maintaining the whiteness of the white cotton fabric present in the wash, compared with using ECE2 detergent alone.

The test results described herein demonstrate that the inclusion of a laundry article according to the invention in a wash cycle not only provides highly effective stain removal, but also maintains the whiteness of white fabrics being washed. In summary, the laundry article of the invention, which is in a user-friendly format for the consumer, is non-tacky to touch and does not contain harsh chemicals, has been shown to produce excellent results.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A laundry article comprising:
(i) a water-insoluble substrate; and
(ii) a dried water-soluble coating provided on the substrate, the dried water-soluble coating comprising:
(a) from about 60% to about 95% by weight of at least one surfactant;
(b) from about 0.5% to about 5% by weight of at least one enzyme;
(c) from about 1% to about 35% by weight of at least one binder; and
(d) from about 0% to about 15% by weight of residual water;
the percentages by weight being percentages by weight of the total dried water-soluble coating.

2. A laundry article according to claim 1, wherein the at least one enzyme comprises a protease, an amylase, a mannanase, a lipase, a cellulase, a pectinase, or a combination thereof.

3. A laundry article according to claim 1, wherein the at least one enzyme is present in an amount of from about 1% to about 4.5%, by weight of the dried water-soluble coating.

4. A laundry article according to claim 3, wherein the at least one enzyme is present in an amount of from about 1% to about 4% by weight of the dried water-soluble coating.

5. A laundry article according to claim 2, wherein the at least one enzyme comprises a combination of a protease and a lipase, optionally in a respective ratio by weight of from about 10:1 to about 20:1.

6. A laundry article according to claim 3, wherein the at least one enzyme is present in an amount of from about 2% to about 4.5% by weight of the dried water-soluble coating.

7. A laundry article according to claim 6, wherein the at least one enzyme comprises a combination of a protease, an amylase, a mannanase, a lipase and a cellulase, optionally in a respective ratio by weight of about 10:4:2:2:1.

8. A laundry article according to claim 1, wherein the dried water-soluble coating comprise other components including, but not limited to, one or more preservatives, pigments, fillers, plasticisers, anti-bacterial agents, dyes, fabric softeners, dye scavenging compounds, anti-soil re-deposition agents, optical brightening agents, UV absorbers, starches, perfumes, and combinations thereof.

9. A laundry article according to claim 8, wherein the dried water-soluble coating comprises at least one preservative in an amount of from about 0.05% to about 10% by weight of the dried water-soluble coating.

10. A laundry article according to claim 8, wherein the dried water-soluble coating comprises at least one pigment in an amount of from about 0.01% to about 2% by weight of the dried water-soluble coating.

11. A laundry article according to claim 1, wherein the water-insoluble substrate is a flexible, absorbent woven or non-woven substrate.

12. A laundry article according to claim 11, wherein the water-insoluble substrate comprises a blend of viscose and polyester.

13. A laundry article according to claim 12, wherein the water-insoluble substrate comprises viscose and polyester and a combination of polyethylene/polypropylene in a ratio by weight in the range of from about 50:35:15 to about 70:15:15.

14. A laundry article according to claim 13, wherein the water-insoluble substrate comprises about 55% by weight viscose, about 30% by weight polyester and about 15% by weight bico, wherein bico is combination of polyethylene and polypropylene.

15. A laundry article according to claim 1, wherein the water-insoluble substrate bears a dye scavenging compound selected from the following compounds:
(i) N-trisubstituted ammonium-2-hydroxy-3-halopropyl compound having the general formula (I) 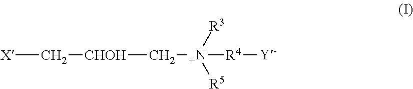
wherein R³, R⁴, R⁵ are each independently methyl, ethyl, butyl or benzyl or an hydroxyl substituted derivative thereof, X′ is a halogen atom, and Y′⁻ is chloride, bromide, sulfate or sulfonate;
and
(ii) a salt of epoxy propyl ammonium having the general formula (II), 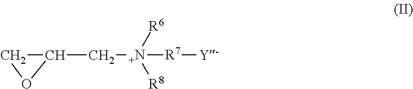
wherein R⁶, R⁷, R⁸ and Y″⁻ have the same meaning as R³, R⁴, R⁵ and Y′⁻, respectively, as defined above; or a combination thereof.

16. A laundry article according to claim 15, wherein the dye scavenging compound is a compound of the formula (I) which is 3-chloro-2-hydroxypropyltrimethylammonium chloride.

17. A laundry article according to claim 15, wherein the dye scavenging compound is a compound of the formula (II) which is glycidyltrimethylammonium chloride.
